(19) United States
(12) Patent Application Publication
(10) Pub. No.: US 2023/0176247 A1
(43) Pub. Date: Jun. 8, 2023

(54) FROST PREDICTION SYSTEM AND METHOD

(71) Applicant: Electronics and Telecommunications Research Institute, Daejeon (KR)

(72) Inventors: Ae Kyeung MOON, Daejeon (KR); Juyoung PARK, Daejeon (KR); Yun Jeong SONG, Daejeon (KR)

(73) Assignee: Electronics and Telecommunications Research Institute, Daejeon (KR)

(21) Appl. No.: 18/076,095

(22) Filed: Dec. 6, 2022

(30) Foreign Application Priority Data
Dec. 7, 2021 (KR) 10-2021-0174104
Feb. 17, 2022 (KR) 10-2022-0020756

(51) Int. Cl. G01W 1/10; G01W 1/02

(52) U.S. Cl. CPC G01W 1/10; G01W 1/02

(57) ABSTRACT

A frost prediction system includes: a weather observation data collection sensor attached to a meteorological station and configured to collect weather observation data and to transmit real-time weather observation data to a server; a training data generation unit configured to generate frost prediction training data by using the collected weather observation data; and a frost prediction unit configured to perform frost prediction for the next day by applying the generated frost prediction training data to a frost learning model.

### BACKGROUND

### 1. Technical Field

The present disclosure relates to a frost prediction system, which predicts a probability of frost for the next day based on a frost learning model and generated input information by utilizing weather observation information and frost occurrence data around the crops in providing a smart agricultural service.

### 2. Related Art

Recently, IoT solutions for various application domains have been developed, and even in the agricultural field, research for data-based precision agriculture for improving agricultural productivity is in progress by increasing the crop yield and reducing a loss through application of IoT technology.

The agriculture performs important functions and roles throughout the community, and is one of fields having been heavily influenced due to recent weather changes.

With the development of big data and artificial intelligence fields, technology that employs the big data and artificial intelligence has been actively applied even to the agricultural field.

In particular, combination of the weather observation data with the agricultural technology has derived positive results in reducing the agricultural disaster caused by the weather change and preparing a preemptive response of the future agriculture.

Meteorological administrations in the existing majority of countries enable users to predict frosts by notifying daily minimum temperatures.

The Korea Meteorological Administration does not have a separate interface for the frost forecast, and only provides a news bulletin notifying that frost may fall.

### SUMMARY

In order to solve the above problem, the present disclosure proposes a frost prediction system, which predicts frost, which exerts a devastating influence on crop growth if being not provided against, by analyzing weather observation data and frost occurrence data through the big data analysis technology and artificial intelligence technology.

Objects of the present disclosure are not limited to the above-described objects, and other unmentioned objects will be able to be clearly understood by those skilled in the art from the following description.

According to an embodiment of the present disclosure to achieve the above objects, a frost prediction system includes: a weather observation data collection sensor attached to a meteorological station and configured to collect weather observation data and to transmit real-time weather observation data to a server; a training data generation unit configured to generate frost prediction training data by using the collected weather observation data; and a frost prediction unit configured to perform frost prediction for the next day by applying the generated frost prediction training data to a frost learning model.

The frost prediction system further includes a database in which date information of a frosty day and the weather observation data collected by the weather observation data collection sensor are stored, and the frost learning model performs learning by matching the frost prediction training data, generated by using the weather observation data stored in the database, with the date information of the frosty day.

The weather observation data include a temperature, humidity, a grass temperature, a wind speed, a soil temperature, an amount of precipitation, and insolation.

The frost prediction training data include a dew point generated by using relative humidity and temperature calculation, a temperature inversion calculated by using a grass temperature and an ambient air temperature, an amount of precipitation in a predetermined rain time zone, an insolation in a predetermined solar time zone, an ambient air temperature in a predetermined time zone, a temperature difference in a predetermined time zone, a wind speed at a predetermined time, a grass temperature in a predetermined time zone, a soil temperature in a predetermined time zone, a dew condensation in a predetermined time zone, a minimum grass temperature in a predetermined time zone, and a minimum ambient air temperature in a predetermined time zone.

The frost prediction system further includes a frost prediction information providing unit configured to transfer the calculated frost prediction information to a user terminal.

The weather observation data solves a class imbalance problem of weather observation data by using oversampling of a synthetic minority oversampling technique (SMOTE).

A frost prediction model is selected through a verification procedure based on actual data, and then is optimized through a grid search and a k-fold cross validation.

According to an embodiment of the present disclosure, a frost prediction method includes: transmitting, by various kinds of weather observation data collection sensors attached to a meteorological station and configured to collect weather observation data, real-time weather observation data to a server; generating frost prediction training data by using the weather observation data; and predicting frost occurrence for the next day by applying the generated frost prediction training data to a frost learning model.

The frost learning model performs learning by matching the frost prediction training data, generated by using the weather observation data stored in a database in which date information of a frosty day and the weather observation data collected by the weather observation data collection sensor are stored, with the date information of the frosty day.

The weather observation data include a temperature, humidity, a grass temperature, a wind speed, a soil temperature, an amount of precipitation, and insolation.

The frost prediction training data include a dew point generated by using relative humidity and temperature calculation, a temperature inversion calculated by using a grass temperature and an ambient air temperature, an amount of precipitation in a predetermined rain time zone, an insolation in a predetermined solar time zone, an ambient air temperature in a predetermined time zone, a temperature difference in a predetermined time zone, a wind speed at a predetermined time, a grass temperature at a predetermined time, a soil temperature in a predetermined time zone, a dew condensation in a predetermined time zone, a minimum grass temperature in a predetermined time zone, and a minimum ambient air temperature in a predetermined time zone.

The frost prediction method further includes transferring the calculated frost prediction information to a user terminal.

The weather observation data solves a class imbalance problem of weather observation data by using oversampling of a synthetic minority oversampling technique (SMOTE).

The predicting of the frost occurrence selects a frost prediction model through a verification procedure based on actual data, and then optimizes the frost prediction model through a grid search and a k-fold cross validation.

The predicting of the frost occurrence collects the weather observation data and the date information of the frosty day, and excludes a non-frosty period in which a frost phenomenon is not observed from the frost prediction training data.

The frost learning model is generated for each collection meteorological station.

The frost learning model is generated for each predetermined time zone.

The frost learning model further includes a common model used in case that the number of collected weather observation data is equal to or smaller than a predetermined number.

According to an embodiment of the present disclosure, since a future frost rate is predicted by using a frost rate prediction system, farmers can prevent damage caused by frost, through providing against the frost.

The present disclosure can use a method for predicting whether it is frosty for the next day by using the weather observation data collected from the surrounding environments, and thus calculate the value of frost occurrence for the next day based on the features extracted from the weather observation data for the previous day.

### BRIEF DESCRIPTION OF THE DRAWINGS

FIG. 1 is a construction block diagram explaining a frost forecast service system according to the present disclosure.

FIG. 2 is a diagram illustrating the structure of an overall system according to an embodiment of the present disclosure.

FIG. 3 is a diagram explaining a learning process of a frost prediction model of FIG. 1.

FIG. 4 is a flowchart explaining a frost forecast service method according to the present disclosure.

FIG. 5 is a block diagram illustrating a computer system for implementing a method according to an embodiment of the present disclosure.

### DETAILED DESCRIPTION

The aspects and features of the present disclosure and methods for achieving the aspects and features will be apparent by referring to the embodiments to be described in detail with reference to the accompanying drawings. However, the present disclosure is not limited to the embodiments disclosed hereinafter, and it can be implemented in various different forms. However, the embodiments are provided to complete the present disclosure and to assist those of ordinary skill in the art in a comprehensive understanding of the scope of the technical idea, and the disclosure is only defined by the scope of the appended claims. Meanwhile, terms used in the description are to explain the embodiments, but are not intended to limit the present disclosure. In the description, unless specially described on the contrary, the constituent element(s) may be in a singular or plural form. In the description, the term “comprises” and/or “comprising” should be interpreted as not excluding the presence or addition of one or more other constituent elements in addition to the mentioned constituent elements.

The present disclosure relates to a prediction system which learns weather observation data and data of a frosty day and predicts and represents a probability of frost for the next day as a frost rate.

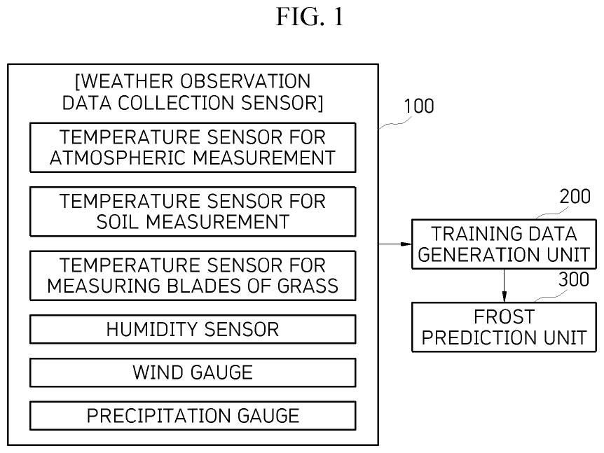

FIG. 1 is a construction block diagram explaining a frost forecast service system according to the present disclosure.

As illustrated in FIG. 1, a frost prediction system according to an embodiment of the present disclosure includes a weather observation data collection sensor 100, a training data generation unit 200, and a frost prediction unit 300.

The weather observation data collection sensor 100 is attached to a meteorological station in an area where frost is to be predicted, and is configured to collect weather observation data and to transmit real-time weather observation data to a server. Here, the weather observation data include a temperature, humidity, a grass temperature, a wind speed, a soil temperature, an amount of precipitation, and insolation. For this, the weather observation data collection sensor 100 includes a temperature sensor for atmospheric measurement, a temperature sensor for soil measurement, a temperature sensor for measuring blades of grass, a humidity sensor, a wind gauge, and a rain gauge.

Meanwhile, the weather observation data may solve a class imbalance problem of weather observation data by using oversampling of a synthetic minority oversampling technique (SMOTE).

The training data generation unit 200 generates frost prediction training data by using the collected weather observation data. Here, as shown in Table 1 below, the frost prediction training data and a dew point generated by using relative humidity and temperature calculation, a temperature inversion calculated by using a grass temperature and an ambient air temperature, an amount of precipitation in a predetermined rain time zone, an insolation in a predetermined solar time zone, an ambient air temperature in a predetermined time zone, a temperature difference in a predetermined time zone, a wind speed at a predetermined time, a grass temperature in a predetermined time zone, a soil temperature in a predetermined time zone, a dew condensation in a predetermined time zone, a minimum grass temperature in a predetermined time zone, and a minimum ambient air temperature in a predetermined time zone.

TABLE 1
Method for processing weather observation data and frost
prediction training data used for learning and prediction

| | Primary model | Secondary model | Tertiary model |
|---|---|---|---|
| | (19:00) | (21:00) | (23:00) |
| Dew point | Relative Humidity | Relative Humidity | Relative Humidity, |
| | | | Temperature |
| | Temperature | Temperature | Calculation |
| | calculation | calculation | |
| Temperature | Grass temperature | Grass temperature | Grass temperature |
| inversion | Air temperature | Air temperature | Air temperature |
| | calculation | calculation | calculation |
| Precipitation | 18:30~19:00 | 20:30~21:00 | 22:30~23:00 |
| Insolation | 12:00~19:00 | 12:00~19:00 | 12:00~19:00 |
| Air temperature | 18:30~19:00 | 20:30~21:00 | 22:30~23:00 |
| Temperature | Max. temperature | Max. temperature | Max. temperature |
| difference | (12:00~16:00) | (12:00~16:00) | (12:00~17:00) |
| (Maximum − | Min. temperature | Min. temperature | Min. temperature |
| Minimum) | (16:00~19:00) | (16:00~21:00) | (17:00~23:00) |
| Wind speed | 17:00~19:00 | 19:00~21:00 | 21:00~23:00 |
| Grass temperature | 12:00~19:00 | 12:00~21:00 | 12:00~23:00 |
| (Calculation | | | |
| equation applied) | | | |
| Soil temperature | 18:30~19:00 | 20:30~21:00 | 22:30~23:00 |
| Dew | 18:30~19:00 | 20:30~21:00 | 22:30~23:00 |
| condensation | | | |
| Minimum grass | 12:00~19:00 | 12:00~21:00 | 12:00~23:00 |
| temperature | | | |
| Maximum grass | 18:30~19:00 | 20:30~21:00 | 22:30~23:00 |
| temperature | | | |

The frost prediction unit 300 performs frost prediction for the next day by applying the generated frost prediction training data to a frost learning model. During the frost prediction, the frost prediction unit 300 excludes data measured in a period in which the frost phenomenon is not observed from frost prediction training data.

That is, the frost learning model calculates frost prediction information for the next day through the frost prediction training data generated through the weather observation data for the present day. Such a frost learning model may be generated and applied for each collection meteorological station and for each predetermined time zone.

Further, a common frost prediction model may be generated and used in case that the number of collected weather observation data is equal to or smaller than a predetermined number.

If the forecast time arrives every day, the frost prediction unit 300 generates the frost prediction training data by processing the weather observation data for the present day. The frost prediction unit 300 puts the frost prediction training data to the frost prediction model as an input value. Thereafter, the frost prediction unit 300 displays the resultant value that is the frost prediction information for the next day, being calculated by the frost prediction model, on a user interface.

A frost prediction information providing unit 400 transfers the calculated frost prediction information to a user terminal. That is, if the frost forecast result exceeds a threshold value, the frost prediction information providing unit 400 sends farmers a notification message in the form of a push of a text or an app. Further, the predicted frost information may be monitored under integrated control, and map-based service micro weather information, frost/pest prediction, and occurrence information display may be performed.

Here, the frost prediction system according to an embodiment of the present disclosure further includes a database in which date information of a frosty day and weather observation data previously collected by the weather observation data collection sensor 100 are stored.

Meanwhile, the frost learning model performs learning by matching the frost prediction training data, generated by using the weather observation data stored in the database (not illustrated), with the date information of the frosty day.

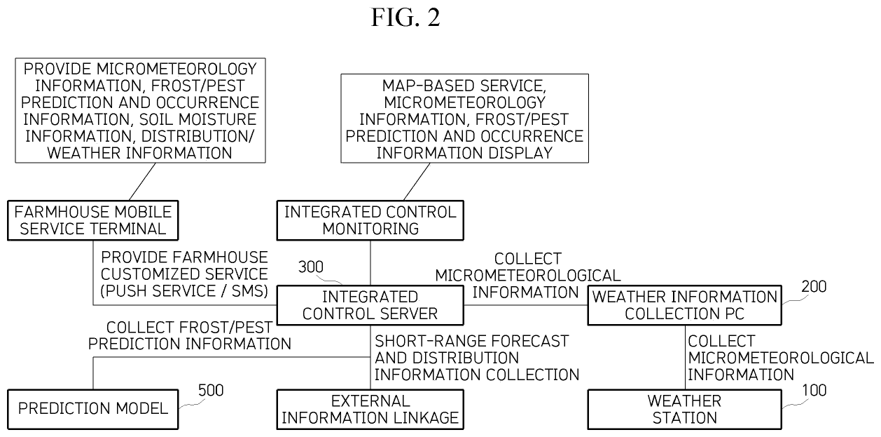

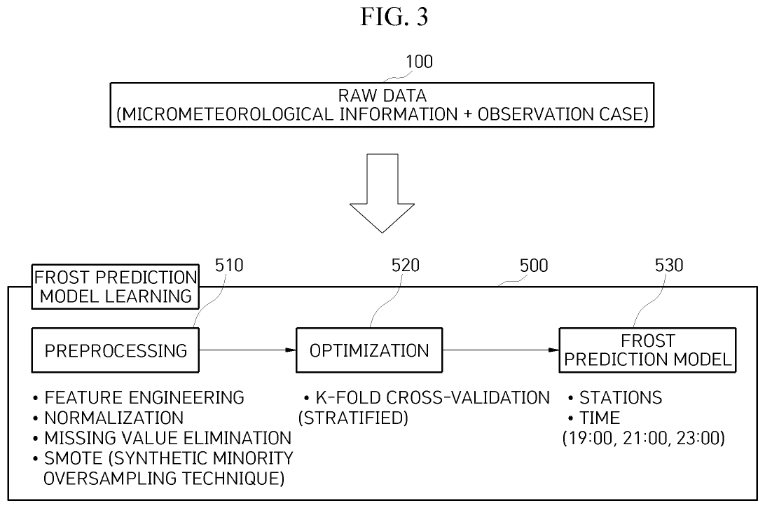

As illustrated in FIG. 3, a prediction model 500 illustrated in FIG. 2 includes a preprocessing unit, an optimization unit 520, and a frost prediction learning unit 530.

The preprocessing unit 510 preprocesses the weather observation data stored in the database. The preprocessing unit 510 detects a feature value, normalizes the weather observation data, performs preprocessing for removing the missing weather observation data, and solves a class imbalance problem for the weather observation data by using oversampling of a synthetic minority oversampling technique (SMOTE).

The optimization unit 520 generates the frost prediction training data by using the preprocessed weather observation data, selects the frost prediction model through a verification procedure based on actual data, and then optimizes the generated frost prediction training data through a grid search and a k-fold cross validation.

By using a machine learning technique, the frost prediction learning unit 530 optimizes the frost prediction model by using the optimized frost prediction training data.

According to an embodiment of the present disclosure, since a future frost rate is predicted by using a frost prediction system, farmers can prevent damage due to frost through providing against frost. That is, a user can provide against the frost for the next day by checking the frost forecast that is derived by using the weather observation data of a weather station at a desired location.

As an example, the weather observation data including the temperature, humidity, grass temperature, wind speed, soil temperature, amount of precipitation, and insolation are collected through the weather observation data collection sensor 100 attached to the meteorological station in an area in which the frost is to be predicted, and the real-time weather observation data are transmitted to the training data generation unit 200 provided in a server. In this case, the weather observation data may solve the class imbalance problem of the weather observation data by using the oversampling of the synthetic minority oversampling technique (SMOTE).

The training data generation unit 200 generates the frost prediction training data by using the collected weather observation data. In the present embodiment, the training data generation unit 200 generates primary frost prediction training data at 19:00, generates secondary frost prediction training data at 21:00, and generates tertiary frost prediction training data at 23:00.

The frost prediction training data include the dew point, the temperature inversion, the amount of precipitation, the insolation, the ambient air temperature, the temperature difference, the wind speed, the grass temperature, the soil temperature, the dew condensation, the minimum grass temperature, and the minimum ambient air temperature. Such frost prediction training data are generated based on the temperature, the humidity, the grass temperature, the wind speed, the soil temperature, the amount of precipitation, and the insolation that are the weather observation data being collected by the weather observation data collection sensor 100.

In the present embodiment, primary frost learning data, secondary frost learning data, and tertiary frost learning data are calculated by using the weather observation data obtained at 19:00, 21:00, and 23:00, respectively.

The dew point of the frost prediction training data is generated by using the relative humidity and temperature calculation in each of 19:00, 21:00, and 23:00 time zones. Further, the temperature inversion of the frost prediction training data is calculated by using the grass temperature and the ambient air temperature in each of 19:00, 21:00, and 23:00 time zones. The amount of precipitation is the amount of precipitation in each of 18:30 to 19:00 time zone, 20:30 to 21:00 time zone, and 22:30 to 23:00 time zone. The insolation in 12:00 to 19:00 time zone is used for all of the primary, secondary, and tertiary frost prediction training data. The ambient air temperature is the ambient air temperature in each of 18:30 to 19:00 time zone, 20:30 to 21:00 time zone, and 22:30 to 23:00 time zone.

A value obtained by subtracting the lowest temperature in 16:00 to 19:00 time zone from the highest temperature in 12:00 to 16:00 time zone is used for all of the primary, secondary, and tertiary frost prediction training data, and the wind speed is the wind speed in each of 17:00 to 19:00 time zone, 19:00 to 21:00 time zone, and 21:00 to 23:00 time zone.

The grass temperature is the grass temperature in each of 12:00 to 19:00 time zone, 20:30 to 21:00 time zone, and 22:30 to 23:00 time zone, and the soil temperature is the soil temperature in each of 18:30 to 19:00 time zone, 20:30 to 21:00 time zone, and 22:30 to 23:00 time zone. The dew condensation is the dew condensation in each of 18:30 to 19:00 time zone, 20:30 to 21:00 time zone, and 22:30 to 23:00 time zone.

The minimum grass temperature is the minimum grass temperature in each of 12:00 to 19:00 time zone, 12:00 to 21:00 time zone, and 12:00 to 23:00 time zone, and the minimum ambient air temperature is the ambient air temperature in each of 18:30 to 19:00 time zone, 20:30 to 21:00 time zone, and 22:30 to 23:00 time zone.

Meanwhile, during the frost prediction, the weather observation data measured in the period in which the frost phenomenon is not observed is excluded from the frost prediction training data.

The frost learning model predicts the frost for the next day by using the obtained primary, secondary, and tertiary frost prediction training data.

Meanwhile, in order to perform data normalization work by using Z score and to solve the data imbalance problem, the oversampling is performed by using the SMOTE method, and the frost prediction unit 300 may optimize the frost prediction learning model by using a random forest classifier and a grid search.

As described above, in case that good-quality learning data can be utilized, the frost prediction model is implemented in each of 19:00, 21:00, and 23:00 time zones by using the weather observation data obtained through a sensor provided for each meteorological station.

Meanwhile, in case that good-quality learning data cannot be utilized, or a new meteorological station requires frost prediction, an applicable common model should be implemented.

As shown in Table 2 below, according to an embodiment of the present disclosure, the common frost prediction model can be used by a meteorological station that has the number of frost prediction learning data equal to or smaller than a predetermine number (e.g., 10).

TABLE 2

| | Station | | | | | | |
|---|---|---|---|---|---|---|---|
| Item | ID | Sum | 2017 | 2018 | 2019 | 2020 | 2021 |
| Gokyung-myeon | 1001 | 20 | 6 | 5 | 3 | 1 | 5 |
| Imgo-myeon | 2001 | 26 | 1 | 7 | 8 | 6 | 4 |
| Hwabuk-myeon | 3001 | 10 | | 3 | 4 | 1 | 2 |
| Hwanam-myeon | 4001 | 19 | 1 | 1 | 6 | 4 | 7 |
| Geumho-eup | 5001 | 15 | | 3 | 4 | 5 | 3 |
| Hwasan-myeon | 6001 | 13 | | 4 | 2 | 5 | 2 |
| Shinnyeong-myeon | 7001 | 4 | 2 | 1 | | | 1 |
| Chungtong-myeon | 8001 | 1 | | 1 | | | |
| Bukahn-myeon | 9001 | 6 | 1 | 2 | | 2 | 1 |
| Daechang-myeon | 9100 | 10 | | | 3 | 2 | 5 |
| Jayang-myeon | 9200 | 201 | 6 | 65 | 56 | 37 | 37 |
| Namboo-dong | 9300 | 3 | | 2 | 1 | | |
| Total sum | | 328 | 17 | 94 | 87 | 63 | 67 |

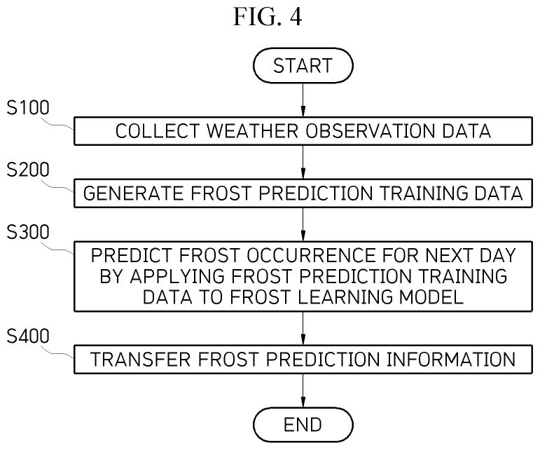

Hereinafter, a frost prediction method according to an embodiment of the present disclosure will be described with reference to FIG. 4.

First, various kinds of sensors attached to a meteorological station and configured to collect weather observation data transmit real-time weather observation data to a server (S100). The weather observation data include a temperature, humidity, a grass temperature, a wind speed, a soil temperature, an amount of precipitation, and insolation. Meanwhile, the weather observation data solve a class imbalance problem of weather observation data by using oversampling of a synthetic minority oversampling technique (SMOTE).

Then, frost prediction training data are generated by using the weather observation data (S200). The frost prediction training data include a dew point generated by using relative humidity and temperature calculation, a temperature inversion calculated by using a grass temperature and an ambient air temperature, an amount of precipitation in a predetermined rain time zone, an insolation in a predetermined solar time zone, an ambient air temperature in a predetermined time zone, a temperature difference in a predetermined time zone, a wind speed at a predetermined time, a grass temperature in a predetermined time zone, a soil temperature in a predetermined time zone, a dew condensation in a predetermined time zone, a minimum grass temperature in a predetermined time zone, and a minimum ambient air temperature in a predetermined time zone.

Thereafter, the frost occurrence for the next day is predicted by applying the generated frost prediction training data to a frost learning model (S300). Here, the frost learning model performs learning by matching the frost prediction training data, generated by using the weather observation data stored in a database in which date information of a frosty day and the weather observation data collected by the weather observation data collection sensor 100 are stored, with the date information of the frosty day.

The predicting of the frost occurrence (S300) collects the weather observation data and the date information of the frosty day, and excludes a non-frosty period in which the frost phenomenon is not observed from the prediction training data.

Further, the calculated frost prediction information is transferred to a user terminal (S400).

According to an embodiment of the present disclosure, it is possible to provide a service that enables a user to provide against frost by transferring calculated frost rate prediction information for the next day to a user.

Hereinafter, a frost prediction model learning method according to an embodiment of the present disclosure will be described.

The frost prediction model is generated by using the frost prediction training data generated by using the weather observation data and the date information of the frosty day. Further, the frost prediction model performs learning through the prediction model 500 by matching the frost prediction training data, generated by using the weather observation data stored in the database, with the date information of the frosty day.

Accordingly, in order to learn the frost prediction model, the prediction model 500 generates the frost prediction training data by using the weather observation data stored in the database.

Further, the prediction model 500 obtains the date information of the frosty day. In the present embodiment, the prediction model 500 may receive the date information of the frosty day from an external information agency such as the meteorological administration.

Thereafter, the prediction model 500 learns the frost prediction model by using the received date information of the frosty day and the frost prediction training data for the day before the day when the frost occurs. In this case, the frost prediction training data include a dew point generated by using relative humidity and temperature calculation, a temperature inversion calculated by using a grass temperature and an ambient air temperature, an amount of precipitation in a predetermined rain time zone, an insolation in a predetermined solar time zone, an ambient air temperature in a predetermined time zone, a temperature difference in a predetermined time zone, a wind speed at a predetermined time, a grass temperature in a predetermined time zone, a soil temperature in a predetermined time zone, a dew condensation in a predetermined time zone, a minimum grass temperature in a predetermined time zone, and a minimum ambient air temperature in a predetermined time zone.

Meanwhile, the prediction model 500 preprocesses the weather observation data stored in the database through the preprocessing unit 510. The preprocessing unit 510 detects the feature value, normalizes the weather observation data, performs preprocessing for removing the missing weather observation data, and solves the class imbalance problem for the weather observation data by using the oversampling of the synthetic minority oversampling technique (SMOTE).

Further, the generated frost prediction model is selected through the verification process based on the actual data, and then is optimized through the grid search and the k-fold cross validation after being. In this case, the machine running technique may be used.

Meanwhile, the frost prediction model may be generated for each predetermined time or for each place, and the common frost prediction model may be generated. Here, the common frost prediction model may be used in case that the number of weather observation data collected by the server is equal to or smaller than the predetermined number.

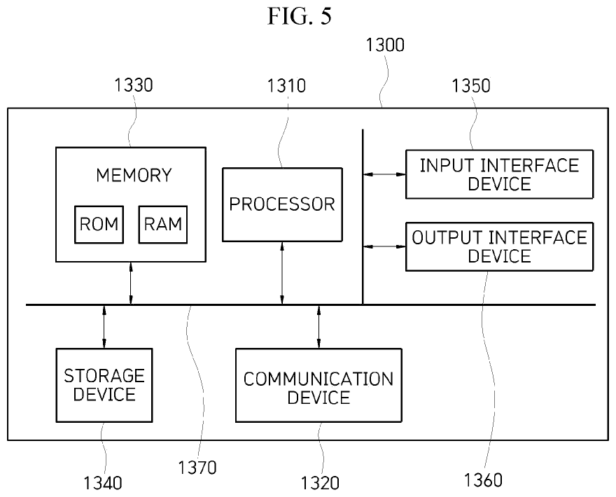

FIG. 5 is a block diagram illustrating a computer system for implementing a method according to an embodiment of the present disclosure.

Referring to FIG. 5, a computer system 1300 may include at least one of a processor 1310 that performs communication through a bus 1370, a memory 1330, an input interface device 1350, an output interface device 1360, and a storage device 1340. The computer system 1300 may also include a communication device 1320 connected to a network. The processor 1310 may be a central processing unit (CPU) or a semiconductor device that executes a command stored in the memory 1330 or the storage device 1340. Examples of the memory 1330 and the storage device 1340 may include various types of volatile or nonvolatile storage medium. For example, the memory may be a read only memory (ROM) or a random access memory (RAM). In an embodiment of the present disclosure, the memory may be located inside or outside the processor, and the memory may be connected to the processor through various known means. Examples of the memory may include various types of volatile or nonvolatile storage medium, and for example, the memory may be a read only memory (ROM) or a random access memory (RAM).

Accordingly, the embodiment of the present disclosure may be implemented as a method implemented in the computer, or may be implemented as a non-transitory computer readable medium storing a computer executable command therein. In an embodiment, when being executed by the processor, the computer readable command may perform a method according to at least one aspect of the present disclosure.

The communication device 1320 may transmit or receive a wired signal or a wireless signal.

Further, the method according to the embodiment of the present disclosure may be implemented in the form of a program command that can be performed through various computer means, and may be recorded in a computer readable medium.

The computer readable medium may include a program command, a data file, and a data structure either alone or in combination. The program command recorded in the computer readable medium may be specially designed and configured for the embodiment of the present disclosure, or may be publicly known to and may be usable by normal technicians in the computer software field. Examples of the computer readable recording medium may include a hardware device configured to store and perform the program command. For example, the computer readable recording medium may be a magnetic medium, such as a hard disk, a floppy disk, or a magnetic type, an optical medium, such as a CD-ROM or a DVD, a magneto-optical medium, such as a floptical disk, a ROM, a RAM, or a flash memory. The program command may include not only a machine language made by a compiler but also a high-level language code that can be executed by a computer through an interpreter.

As described above, although the configuration of the present disclosure has been described in detail with reference to the accompanying drawings, this is only for illustrative purposes, and various modifications and changes are possible within the range of the technical idea of the present disclosure by those of ordinary skill in the art to which the present disclosure pertains. Accordingly, the scope of the present disclosure should not be limited to the above-described embodiments, but should be determined by the description of the appended claims.

What is claimed is:

1. A frost prediction system comprising:
a weather observation data collection sensor attached to a meteorological station and configured to collect weather observation data and to transmit real-time weather observation data to a server;
a training data generation unit configured to generate frost prediction training data by using the collected weather observation data; and
a frost prediction unit configured to perform frost prediction for the next day by applying the generated frost prediction training data to a frost learning model.

2. The frost prediction system of claim 1, further comprising a database in which date information of a frosty day and the weather observation data collected by the weather observation data collection sensor are stored,
wherein the frost learning model performs learning by matching the frost prediction training data, generated by using the weather observation data stored in the database, with the date information of the frosty day.

3. The frost prediction system of claim 1, wherein the weather observation data include a temperature, humidity, a grass temperature, a wind speed, a soil temperature, an amount of precipitation, and insolation.

4. The frost prediction system of claim 1, wherein the frost prediction training data include a dew point generated by using relative humidity and temperature calculation, a temperature inversion calculated by using a grass temperature and an ambient air temperature, an amount of precipitation in a predetermined rain time zone, an insolation in a predetermined solar time zone, an ambient air temperature in a predetermined time zone, a temperature difference in a predetermined time zone, a wind speed at a predetermined time, a grass temperature in a predetermined time zone, a soil temperature in a predetermined time zone, a dew condensation in a predetermined time zone, a minimum grass temperature in a predetermined time zone, and a minimum ambient air temperature in a predetermined time zone.

5. The frost prediction system of claim 1, further comprising a frost prediction information providing unit configured to transfer the calculated frost prediction information to a user terminal.

6. The frost prediction system of claim 1, wherein the weather observation data solves a class imbalance problem of weather observation data by using oversampling of a synthetic minority oversampling technique (SMOTE).

7. The frost prediction system of claim 4, wherein a frost prediction model is selected through a verification procedure based on actual data, and then is optimized through a grid search and a k-fold cross validation.

8. A frost prediction method comprising:
transmitting, by various kinds of weather observation data collection sensors attached to a meteorological station and configured to collect weather observation data, real-time weather observation data to a server;
generating frost prediction training data by using the weather observation data; and
predicting frost occurrence for the next day by applying the generated frost prediction training data to a frost learning model.

9. The frost prediction method of claim 8, wherein the frost learning model performs learning by matching the frost prediction training data, generated by using the weather observation data stored in a database in which date information of a frosty day and the weather observation data collected by the weather observation data collection sensors are stored, with date information of the frosty day.

10. The frost prediction method of claim 8, wherein the weather observation data include a temperature, humidity, a grass temperature, a wind speed, a soil temperature, an amount of precipitation, and insolation.

11. The frost prediction method of claim 8, wherein the frost prediction training data include a dew point generated by using relative humidity and temperature calculation, a temperature inversion calculated by using a grass temperature and an ambient air temperature, an amount of precipitation in a predetermined rain time zone, an insolation in a predetermined solar time zone, an ambient air temperature in a predetermined time zone, a temperature difference in a predetermined time zone, a wind speed at a predetermined time, a grass temperature in a predetermined time zone, a soil temperature in a predetermined time zone, a dew condensation in a predetermined time zone, a minimum grass temperature in a predetermined time zone, are a minimum ambient air temperature in a predetermined time zone.

12. The frost prediction method of claim 8, further comprising transferring the calculated frost prediction information to a user terminal.

13. The frost prediction method of claim 8, wherein the weather observation data uses oversampling of a synthetic minority oversampling technique (SMOTE).

14. The frost prediction method of claim 8, wherein the predicting of the frost occurrence selects a frost prediction model through a verification procedure based on actual data, and then optimizes the frost prediction model through a grid search and a k-fold cross validation.

15. The frost prediction method of claim 8, wherein the predicting of the frost occurrence collects the weather observation data and the date information of a frosty day, and
excludes a non-frosty period in which a frost phenomenon is not observed from learning data.

16. The frost prediction method of claim 6, wherein the frost learning model is generated for each collection meteorological station.

17. The frost prediction method of claim 8, wherein the frost learning model is generated for each predetermined time zone.

18. The frost prediction method of claim 8, wherein the frost learning model further comprises a common model used in case that the number of collected weather observation data is equal to or smaller than a predetermined number.

19. A frost prediction model learning method comprising:
generating frost prediction training data by using weather observation data stored in a database;
obtaining date information of a frosty day; and
learning a frost prediction model by using the date information of the frosty day and the frost prediction training data for the day before the frosty day.

20. The frost prediction model learning method of claim 19, wherein the frost prediction training data include a dew point generated by using relative humidity and temperature calculation, a temperature inversion calculated by using a grass temperature and an ambient air temperature, an amount of precipitation in a predetermined rain time zone, an insolation in a predetermined solar time zone, an ambient air temperature in a predetermined time zone, a temperature difference in a predetermined time zone, a wind speed at a predetermined time, a grass temperature in a predetermined time zone, a soil temperature in a predetermined time zone, a dew condensation in a predetermined time zone, a minimum grass temperature in a predetermined time zone, and a minimum ambient air temperature in a predetermined time zone.
